(19) United States
(12) Patent Application Publication
(10) Pub. No.: US 2010/0263756 A1
(43) Pub. Date: Oct. 21, 2010

(54) GAS INJECTION SYSTEM

(76) Inventor: THOMAS UHL, Lohra (DE)

Correspondence Address: BRINKS HOFER GILSON & LIONE, P.O. BOX 10395, CHICAGO, IL, 60610, US

(21) Appl. No.: 12/756,627

(22) Filed: Apr. 8, 2010

(30) Foreign Application Priority Data
Apr. 16, 2009 (DE) DE 102009017648.9

(51) Int. Cl. A01G 25/16

(52) U.S. Cl. 137/625

(57) ABSTRACT

A gas injection system includes a first line for introducing gas into an ion source, and a second line and a third line for two separate gas flows, which are introduced into the ion source. A fast switchover between the gas flows is effected using a multi-way switchover valve. The second line and the third line each lead into an inlet of the multi-way switchover valve, and the first line is connected to an outlet of the multi-way switchover valve. The multi-way switchover valve is configured such that either the gas flow from the second line or the gas flow from the third line is introduced into the ion source via the first line.

The present patent document claims the benefit of DE 10 2009 017 648.9, filed Apr. 16, 2009, which is hereby incorporated by reference.

### BACKGROUND

The present embodiments relate to a gas injection system.

In a particle therapy treatment (e.g., of cancers), a particle beam including, for example, protons or heavy ions (e.g. carbon ions) is generated. The particle beam is generated in an accelerator and guided into a treatment room where the particle beam enters via an exit window. The particle beam may be directed into different treatment rooms in alternation by the accelerator. In the treatment room, a patient who is to receive the therapy is positioned (e.g., on a patient examination table) and may be immobilized.

In order to generate the particle beam, the accelerator includes an ion source such as, for example, an electron cyclotron resonance ion source (ECR ion source). In the ion source, a directed movement of free ions having a specific energy distribution is generated. In this case, positively charged ions, such as protons or carbon ions, are used for irradiating certain tumors. The positively charged ions can be driven to high energies with the aid of the accelerator and release energy very precisely in the body tissue. The particles generated in the ion source circulate in a synchrotron ring in an orbit at more than 50 MeV/u, for example. A pulsed particle beam having predefined energy, focusing and intensity is provided for the therapy.

In order to generate the particles, a gas, which is to be ionized, is introduced into the ion source. A highly precise and constant gas flow of the supplied gas is used for a defined particle beam. In order to enable different gases such as, for example, carbon dioxide or hydrogen to be introduced in alternation into the ion source according to the type of treatment planned, separate lines that lead into the ion source are provided for the gas flows. For example, when the gas flow is switched over in order to generate a new particle beam, the gas lines of the current operating gas are first closed, the system is purged, and then, the other gas flow is introduced into the ion source.

It is, however, difficult, and therefore time-consuming, to set a highly precise desired gas flow. The flow rates are dependent on the type of gas chosen and are generally less than 1 sccm (standard cubic centimeter per minute). For carbon dioxide in the case of a sputter ion source, the flow rate may be around 0.002 sccm, and in the case of an ECR ion source, the flow rate may be around 0.3 sccm.

In order to set the pressure and hence the gas flow in the gas lines, temperature-controlled needle valves are used. A precise setting of the desired low rate of flow is difficult using temperature-controlled needle valves. Since a direct measurement of the flow rates cannot be made with the desired accuracy, a flow rate is set by measuring the generated particle beam and successively adjusting the needle valve according to the trial-and-error principle. The needle valves are also very sensitive to temperature. Variations in the ambient temperature therefore lead to fluctuations in the flow rate. For this reason, the ambient temperature is kept stable within 2° C. In addition, the parameters of the system are reset after replacement of components (e.g. of valves arranged in the lines).

### SUMMARY AND DESCRIPTION

The present embodiments may obviate one or more of the drawbacks or limitations in the related art. For example, in one embodiment, a fast switchover between the different gases that are introduced into the ion source is provided.

In one embodiment, a gas injection system (e.g., for a particle therapy system) includes a first line for introducing gas into an ion source, a second line and a third line for two separate gas flows, and a multi-way switchover valve. The second line and the third line each lead into an inlet of the multi-way switchover valve, and the first line is connected to an outlet of the multi-way switchover valve. The multi-way switchover valve is configured to alternatively connect one inlet or another inlet to the outlet such that either the second line or the third line is connected in flow relationship to the first line.

An advantage of the gas injection system is that by using the multi-way switchover valve, a rapid switchover takes place between the second line and the third line, such that the gas flow from the second line or the third line is introduced into the first line or the ion source in alternation. The switchover time for the multi-way switchover valve may be less than 1 second, and after fewer than 5 seconds, the gas flow in the first line is stable. A new constant gas flow may be set within a few seconds, and the type of ions in the particle beam may be changed without cleaning the gas injection system when the operating gas is changed.

A switchover valve may be a valve, which alternately connects the one or another inlet in flow relationship to the outlet without mixing the two gas flows. An effectively digital switchover therefore takes place between the gas flows.

Another advantage, when using the multi-way switchover valve, is that one line, through which different gas flows are alternately introduced into the ion source, is used with the result that a reduced space is used.

In one embodiment, the multi-way switchover valve includes a second outlet. The line not communicating in flow relationship with the first line (e.g., the non-communicating line) is connected to the second outlet. In this way, the gas that is not being introduced into the ion source also flows (e.g., continuously) out of the multi-way switchover valve so that a stable gas flow is established.

In one embodiment, a pump (e.g., a vacuum pump) may be connected to the second outlet. The line not communicating in flow relationship with the first line (e.g., the second line 10 or the third line 12) via the multi-way switchover valve to supply gas to the ion source is connected to the pump, such that the gas in is continuously aspirated out of the gas injection system. In this case, the vacuum pump simulates the evacuated ion source. The flow parameters for the gas flows, consequently, do not change during the operation of the particle therapy system, even when one of the gas flows is not being used for generating the particle beam. When stable gas flows have become established in the second and third lines, the gas flows may not be interrupted, even if one of the gas flows is not being introduced into the ion source. In one embodiment, the gas flows are interrupted if the gas flows are not used for longer than, for example, 30 minutes. In one embodiment, an additional on/off valve is installed in each line upstream of the multi-way switchover valve for interrupting the gas flow. During operation of the particle therapy system, the gas flows stream continuously either in the direction of the ion source or out of the gas injection system. Since the gas flows are very small (e.g., lying in the region of a few standard microliters per minute), the gas losses are very small.

In one embodiment, the multi-way switchover valve is a 2-position 4-way valve. Accordingly, the valve has two inlets and two outlets, thereby enabling two gas flows to pass through the valve in parallel in two different directions. When the valve is switched over, each of the inlets is connected to the other outlet, with the result that the direction of the gas flows is changed from the valve.

In one embodiment, the gas injection system includes an additional multi-position valve, which is connected in flow relationship to one of the inlets of the multi-way switchover valve, to enable more than two gas flows to be introduced into the ion source. The multi-position valve is connected upstream of the multi-way switchover valve. The second and third lines, as well as at least one further line, are connected on the inlet side of the multi-way switchover valve. This enables a plurality of gas flows to be introduced alternately into the multi-way switchover valve through one of the inlets of the multi-way switchover valve.

In one embodiment, the second and third lines are formed at least in sections from capillary tubes (e.g., glass capillary tubes) for setting the volume flow. Owing to the vacuum prevailing in the ion source, the gas in the gas injection system makes its way to the ion source. In one embodiment, the gas is provided from a gas reservoir at a pressure of several bar (e.g., 2 bar). In order to set the desired flow rate, the capillary tubes are provided to achieve a precise and reliable constant pressure reduction (e.g., from about 2 bar to almost 0 bar). The capillary tubes are provided to set a gas volume flow with little fluctuation and that is minimally dependent on environmental factors. The properties of the capillary tubes, such as, for example, length and internal diameter, are chosen taking into account the pressure on a high-pressure side (e.g., 2 bar) and a low-pressure side (e.g., 0 bar) such that the desired drop in pressure takes place along the capillary tubes. At the same time, the gas flow is kept constant owing to the constant pressure difference between the high-pressure side and the vacuum in the ion source.

In one embodiment, the glass capillary tube is a passively acting throttle element, which is insensitive to external influences such as, for example, variations in temperature. The capillary tubes constitute the narrowest sections of the lines and have an outer diameter, which is less than 1 mm and (e.g., in particular, less than 0.5 mm), and a length of several decimeters or several meters. The capillary tubes open out into the valves and accessories or into a section of line having a larger diameter, the flow rate of the gas that is set using a capillary tube remaining constant downstream. Because the pressure drop in the gas injection system is regulated via the capillary tubes, there is no need to check the settings after replacement of a valve and no fine adjustment is necessary. The parameter settings of the gas injection system are highly reproducible.

In one embodiment, the gas injection system includes a control system, which determines the flow rate of the gas supplied through the first line of the ion source from the geometric data of the capillary tubes.

In one embodiment, at least two forelines lead into and are connected to the second line via a Y connector in order to form a gas mixture. The gas that is to be ionized may be transported into the ion source with the aid of a carrier gas (e.g., an inert gas). In order to achieve a good mixing of the two gases, the forelines lead into the second line at the same point, this being realized using a Y connector.

In one embodiment, a stop valve is provided in each of the forelines for the purpose of interrupting the gas flows before the gas flows have become mixed together. In one embodiment, stop valves are provided upstream of the inlets of the multi-way switchover valve. Analogously, in one embodiment, a stop valve is provided between the multi-way switchover valve and the ion source. The stop valves are opened and closed at the time of startup and shutdown, respectively, of the particle therapy system, thereby regulating the provisioning of the operating gases. The corresponding stop valve is also closed if an operating gas is not required for longer than 30 minutes, for example, and is reopened about 5 minutes before the operating gas is reused, for example. The stop valves are also closed individually or in groups when malfunctions occur during operation, thereby interrupting the gas flows in the different line sections of the gas injection system.

In one embodiment, the gas injection system includes a control system to allow centralized control of the valves. The complex gas injection system is controlled from a central point and has a high degree of automation and synchronization.

In one embodiment, a method for operating a gas injection system (e.g., for a particle therapy system) is provided. The method for operating the gas injection system includes introducing gas from a multi-way switchover valve into an ion source via a first line. A second line and a third line are connected to the multi-way switchover valve in such a way that either a gas flow from the second line or a gas flow from the third line is introduced via the first line into the ion source.

The advantages and embodiments presented in relation to the gas injection system are to be applied analogously to the method.

With the described method, a stable gas flow is set regardless of whether gas is introduced into the ion source from the second or the third line. In one embodiment, the gas injection system is controlled such that during operation, while the gas flow from the second line is being introduced into the ion source, the gas flow from the third line is aspirated by a pump via the multi-way switchover valve. When the multi-way switchover valve is switched over, the gas flow from the third line is introduced into the ion source, and the gas flow from the second line is aspirated by the pump via the multi-way switchover valve.

### BRIEF DESCRIPTION OF THE DRAWINGS

FIG. 1 shows one embodiment of a gas injection system for a particle therapy system having a multi-way switchover valve in a first position, and

FIG. 2 shows one embodiment of the gas injection system according to FIG. 1 having the multi-way switchover valve in a second position.

### DETAILED DESCRIPTION OF THE DRAWINGS

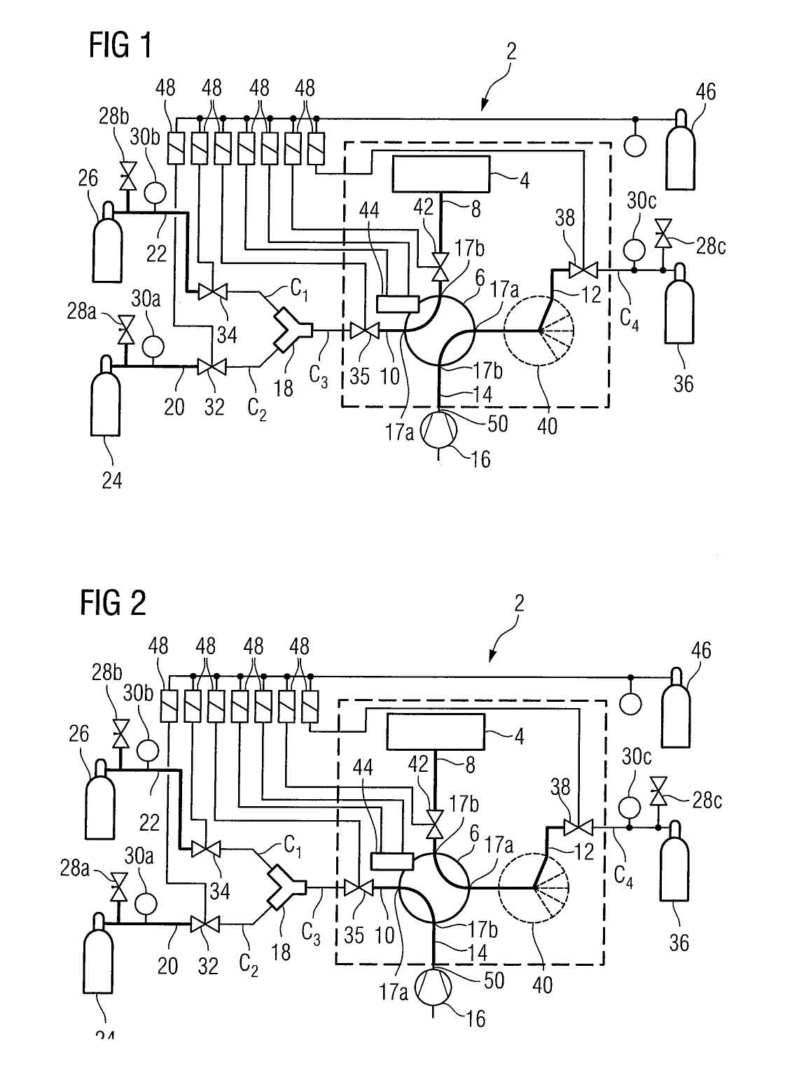

FIG. 1 shows a gas injection system 2, which includes an ion source 4 and a multi-way switchover valve 6 (e.g., a valve 6) connected upstream of the ion source 4. Starting from the valve 6, a first line 8 leads to the ion source 4, and second and third lines 10, 12 lead into the valve 6. A vacuum pump 16 is connected to the valve 6 via a fourth line 14. In one embodiment, the first line 8, the second line 10, and the third line 12 are stainless steel.

In one embodiment, the valve 6 is a 2-position 4-way valve (e.g., the valve 6 has four ports: two inlets 17a for the second line 10 and the third line 12; and two outlets 17b for the first line 8 and the fourth line 14). By combinations when the two inlets 17a are connected to the two outlets 17b, two positions of the valve 6 are produced, which are explained in connection with FIG. 2.

A Y connector 18 is arranged in the second line 10 such that two forelines 20, 22 lead into the second line 10 at the same point. Carbon dioxide is provided via the foreline 20 from a first pressure vessel 24 with low-flow pressure reducer. Helium is used as a carrier gas, the helium being stored in a second pressure vessel 26 with low-flow pressure reducer and passing via the foreline 22 to the second line 10 in which the helium mixes with the carbon dioxide in the region of the Y connector 18. Each of the two forelines 20, 22 has a needle valve 28a, 28b (e.g., low-pressure valves 28a, 28b), a pressure sensor 30a, 30b for measuring the pressure in the forelines 20, 22, and a stop valve 32, 34 for interrupting the respective gas flow from the pressure vessels 24, 26. The low-pressure valves 28a, 28b allow fast regulation of the pressure in the forelines 22, 24. When the pressure is reduced in a line, the pressure changes slowly at a flow rate of approximately 1 sccm. In order to speed up the adjustment, the withdrawal of gas through the needle valves 28a, 28b is increased.

Hydrogen may be introduced into the ion source 4 via the third line 12 from a further pressure vessel 36 with low-flow pressure reducer in order to generate a particle beam from protons. A needle valve 28c, a pressure sensor 30c and a stop valve 38 are arranged in the hydrogen line. In one embodiment, a multi-position valve 40, through which further gases (e.g., oxygen) are introduced into the ion source 4 via the third line 12, is connected upstream of the valve 6.

A stop valve 42 is arranged in the first line 8 between the valve 6 and the ion source 4 such that the gas flow may be interrupted after the valve 6.

The gas injection system 2 also includes a control system 44 to allow centralized control of at least the stop valves 32, 34, 35, 38 and 42. The stop valves 32, 34, 35, 38 and 42 are controlled pneumatically using compressed air from a pressure vessel 46 with low-flow pressure reducer. The air is supplied and discharged using electric valves 48, which are controlled digitally.

In the gas injection system 2, the gas is transported to the evacuated ion source 4 or to the vacuum pump 16, owing to the pressure difference between the pressure vessels 24, 26, 36, in which originally there is a pressure of about 2 bar, for example. In one embodiment, sections of the two forelines 20, 22 between the stop valves 32, 34 and the Y connector 18, a section of the second line 10 between the Y connector 18 and the stop valve 35, and a section of the third line 12 between the pressure vessel 36 and the stop valve 38 are capillary tubes C₁, C₂, C₃ (e.g., glass capillary tubes) in order for a pressure drop from 2 bar to almost 0 bar to be realized. The length and the internal diameter of the capillary tubes C₁, C₂, C₃ are chosen such that the desired pressure drop can take place along the capillary tubes C₁, C₂, C₃. The length of the capillary tubes C₁, C₂, C₃ varies in the decimeter or meter range (e.g., the desired drop in pressure is realized on a section of approximately 2 m). The outer diameter of the capillary tubes C₁, C₂, C₃ may be less than 1 mm (e.g., in the range of 0.2 to 0.3 mm), and the internal diameter may be about power 10⁻¹ smaller than the outer diameter (e.g., 0.02 to 0.06 mm).

In one embodiment, the gas injection system 2 is configured such that the helium and the carbon dioxide are introduced into the ion source 4 at a desired flow rate. In order to prevent a backflow of the carbon dioxide into the helium foreline 22, and vice versa, the capillary tube C₁ is arranged between the helium stop valve 34 and the Y connector 18, and the capillary tube C₂ is arranged between the carbon dioxide stop valve 32 and the Y connector 18. This results in a higher pressure on the helium stop valve 24 side by comparison with the Y connector 18, with the result that the direction of the gas flow is predetermined.

The carbon dioxide gas flow is routed via a glass capillary tube C₂ to the Y connector 18, and there, injected into the helium. The properties of the capillary tube C₂ and the pressure of the carbon dioxide determine the concentration of carbon dioxide in helium. After the flow rates of helium and carbon dioxide have been set (e.g., to 0.3 sccm) in each case using the capillary tubes C₂ and C₂, the glass capillary tube C₃ is provided from the Y connector 18 to the stop valve 35 to transport the gas to the ion source 4.

The drop in pressure between the hydrogen vessel 36 and the stop valve 38 is set analogously using a capillary tube C₄.

Before the gas mixture stop valve 35 is closed, the stop valves 32 and 34 for the carbon dioxide and the helium are closed in order to avoid a mixing of the gases in the pressure vessels 24, 26 due to diffusion.

The gas flows from the second line 10 and the third line 12 are introduced into the 2-position 4-way valve 6. The valve is set to select whether the helium/carbon dioxide gas mixture or the hydrogen is supplied to the ion source 4. FIG. 1 shows a first position of the valve 6 in which the gas mixture is fed from the second line 10 via the first line 8 into the ion source 4. In parallel, the hydrogen from the third line 12 is aspirated after the valve 6 (e.g., a standby gas), by the vacuum pump 16, the operating conditions in the ion source 4 being simulated by the vacuum pump 16. As a result of the continuous aspiration of the hydrogen by the vacuum pump 16, a stable flow may become established before a switchover of the valve 6 causes the hydrogen to be introduced into the ion source 4. If the standby gas (e.g., the hydrogen in FIG. 1) from the third line 12 is not used for a comparatively long time, the corresponding stop valve 38 may be closed in order to minimize the gas losses.

FIG. 2 shows the second position of the valve 6. Like reference signs have the same meaning in the different Figures. After a switchover of the valve 6, hydrogen from the third line 12 is introduced into the ion source 4, and the helium/carbon dioxide gas mixture from the second line 10 is aspirated by the vacuum pump 16.

Using the valve 6, a fast switchover of the gas flows may be effected. After the switchover, a previous operating gas, which was previously fed into the ion source 4, is directed out of the gas injection system 2 using the vacuum pump 16, and a previous standby gas, in which a stable flow has become established, is introduced into the first line 8 and into the ion source 4. In one embodiment, such a switchover process takes about 0.5 seconds, and after less than 5 seconds, the gas flow in the direction of the ion source 4 has stabilized.

The first, second, third, and fourth lines 8, 10, 12 and 14 are made of stainless steel and are therefore at the electric potential of the ion source 4 (e.g., about 24 kv). The area of high potential is indicated in the figures using a dashed block, the area of high potential being defined by the electrically insulating glass capillary tubes C₃ and C₄ along the lines 10 and 12. With regard to an electrical isolation, the connection between the valve 6 and the vacuum pump 16 is also realized using a glass tube 50.

For maintenance of the gas injection system 2 or when a component is replaced, the stop valve 42 directly in front of the ion source 4 may be closed. The stop valve 42 may also be used to shut off the gas flow into the ion source 4 quickly in the event of a power failure.

A further advantage of the gas injection system 2 is that the settings of the gas flow after maintenance are reproducible. Because the flow rates of the gas flows are regulated using the pressure difference on both sides of the first, second, and third lines 8, 10, 12, the replacement of any valve in the gas injection system 2 does not result in changes in the pressure along the first, second, and third lines 8, 10, 12. The gas injection system 2 is designed in such a way that no dead volume zones are created.

The gas injection system 2 and the ion source 4 are part of a particle therapy system (not shown in further detail here) for generating a particle beam from positively charged particles. In order to generate the ions, the operating gas is introduced from the vessels 24, 26 or 36 into a plasma chamber of the ion source 4 using the gas injection system 2. Either the helium/carbon dioxide gas mixture from the line 10 or the hydrogen from the line 12 is supplied alternately to the ion source 4 as a function of the type of particle beam. The generated ions are accelerated on a synchrotron ring of the particle therapy system using magnets to a final energy of more than 50 MeV/u (at a bombarding energy of 7 MeV/u) and directed onto a body region of a patient that is to be treated.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A gas injection system for an ion source, the gas injection system comprising:
a first line for introducing gas into an ion source;
a second line and a third line for two separate gas flows; and
a multi-way switchover valve comprising a first inlet, a second inlet, and an outlet,
wherein the second line and the third line lead into the first inlet and the second inlet of the multi-way switchover valve, and
wherein the first line is connected to the outlet of the multi-way switchover valve, and the multi-way switchover valve is configured to alternatively connect the first inlet or the second inlet to the outlet such that either the second line or the third line is connected in flow relationship to the first line.

2. The gas injection system as claimed in claim 1, wherein the multi-way switchover valve comprises a second outlet, and wherein either the second line or the third line not connected in flow relationship to the first line is connected to the second outlet.

3. The gas injection system as claimed in claim 2, wherein a pump is connected to the second outlet.

4. The gas injection system as claimed in claim 1, wherein the multi-way switchover valve is a 2-position 4-way valve.

5. The gas injection system as claimed in claim 1, further comprising an additional multi-position valve, which is connected in flow relationship to the first inlet or the second inlet of the multi-way switchover valve.

6. The gas injection system as claimed in claim 1, wherein the second line and the third line are formed in sections from capillary tubes for the purpose of setting a gas volume flow.

7. The gas injection system as claimed in claim 6, further comprising a control system, which determines a flow rate of the gas supplied to the ion source through the first line from the geometric data of the capillary tubes.

8. The gas injection system as claimed in claim 1, further comprising at least two forelines that lead into the second line in order to form a gas mixture, the two forelines being connected to the second line via a Y connector.

9. The gas injection system as claimed in claim 8, wherein a stop valve is provided in each of the at least two forelines.

10. The gas injection system as claimed claim 9, further comprising stop valves arranged upstream of the first inlet and the second inlet of the multi-way switchover valve.

11. The gas injection system as claimed in claim 10, further comprising a stop valve arranged between the multi-way switchover valve and the ion source.

12. The gas injection system as claimed in claims 8, wherein the control system is configured for centralized control of the stop valves.

13. A method for operating a gas injection system for an ion source, the method comprising:
introducing gas from a multi-way switchover valve into an ion source via a first line,
wherein a second line and a third line are connected to the multi-way switchover valve such that either a gas flow from the second line or a gas flow from the third line is introduced into the ion source via the first line.

14. The method as claimed in claim 13, further comprising controlling the gas injection system such that the gas flow from the third line is aspirated by a pump via the multi-way switchover valve when the gas flow is being introduced into the ion source from the second line, and when the multi-way switchover valve is switched over, the gas flow from the third line is introduced into the ion source, and the gas flow from the second line is aspirated by the pump via the multi-way switchover valve.

15. The gas injection system as claimed in claim 2, wherein the second line and the third line are formed in sections from capillary tubes for the purpose of setting the gas volume flow.

16. The gas injection system as claimed in claim 5, wherein the second line and the third line are formed in sections from capillary tubes for the purpose of setting the gas volume flow.

17. The gas injection system as claimed in claim 7, further comprising at least two forelines that lead into the second line in order to form a gas mixture, the two forelines being connected to the second line via a Y connector.

18. The gas injection system as claimed claim 1, further comprising stop valves arranged upstream of the first inlet and the second inlet of the multi-way switchover valve.

19. The gas injection system as claimed in claim 1, further comprising a stop valve arranged between the multi-way switchover valve and the ion source.

20. The gas injection system as claimed in claims 10, wherein the control system is configured for centralized control of the stop valves.
